(19) United States
(12) Patent Application Publication
(10) Pub. No.: US 2026/0148446 A1
(43) Pub. Date: May 28, 2026

(54) ARTIFICIAL INTELLIEGENCE FASHION SYSTEM

(71) Applicant: iFashions Inc, Lafayette, CA (US)

(72) Inventor: Ying Zheng, Lafayette, CA (US)

(73) Assignee: iFashions Inc, Lafayette, CA (US)

(21) Appl. No.: 18/959,500

(22) Filed: Nov. 25, 2024

(51) Int. Cl. G06T 11/60; G06T 7/00; G06T 11/00

(52) U.S. Cl. CPC G06T 11/60; G06T 7/0002; G06T 11/10; G06T 2200/24; G06T 2207/10024; G06T 2207/20081; G06T 2207/20092; G06T 2207/30168; G06T 2210/16

(57) ABSTRACT

Embodiments of the present disclosure may include a system for generating and scoring user-customized fashion images, including a memory including an image-generative artificial intelligence engine trained to generate realistic images of fashion items.

### BACKGROUND OF THE INVENTION

Embodiments of the present disclosure may include a system for generating and scoring user-customized fashion images using an artificial intelligence system.

### BRIEF SUMMARY

Embodiments of the present disclosure may include a system for generating and scoring user-customized fashion images, including a memory including an image-generative artificial intelligence (AI) engine trained to generate realistic images of fashion items. Embodiments may also include an image-analysis engine trained to generate output of images.

Embodiments may also include an artificial intelligence scoring network trained to score the realistic images of fashion items generated by the image-generative artificial intelligence engine. Embodiments may also include at least one processor. Embodiments may also include at least one non-transitory computer-readable storage medium storing instructions that, when executed by the at least one processor, cause the system to generate a first realistic synthesized image utilizing the image-generative artificial intelligence engine based on a set of inputs from a user.

In some embodiments, the set of inputs may include attributes of a clothing article. In some embodiments, the attributes of the clothing article may include color, style, occasion, age of the user, material, pattern, print, and length. In some embodiments, the user may be provided with an interactive user interface for entering the set of inputs.

In some embodiments, the user may be able to view the first realistic synthesized image after the user enters the set of inputs. In some embodiments, the user may be able to edit details of the clothing article. In some embodiments, the details may include any part of the clothing article. In some embodiments, the any part of the clothing article may include at least any part of collar and any part of sleeve.

In some embodiments, the user may be able to hand draw any shape or pattern on the clothing article. Embodiments may also include generate a first output dataset from the first realistic synthesized image utilizing the image-analysis engine. In some embodiments, the first output dataset may include information on color distribution and shape distribution of the first realistic synthesized image.

Embodiments may also include determine a first score for the first output dataset utilizing the artificial intelligence scoring network. Embodiments may also include generate a second score with inputs of a set of fashion designers on the first realistic synthesized image. Embodiments may also include train the image-generative artificial intelligence engine for better generation of realistic images of fashion items based on the differences and interactions of the first score and the second score.

In some embodiments, the user can edit the details of the clothing article via a smart UI system. In some embodiments, the user may be able to change color, shape, style, print, and other details of the clothing article by a smart input device coupled to the smart UI system. In some embodiments, the user can upload inspirational photos and drawings to guide the AI generation of the clothes or a specific part of the clothes.

In some embodiments, the user can see how they or a user-selected model look like in the AI-generated clothes. In some embodiments, the user can upload their or a model's photo to the system. In some embodiments, the user can put accessories on the user's body. In some embodiments, the accessories can be bags, earrings, headbands, makeups. In some embodiments, the user can upload a picture of a bag. In some embodiments, the first realistic synthesized image contains the picture of the bag with the user.

Embodiments of the present disclosure may also include a method for generating and scoring user-customized fashion images, including generating a first realistic synthesized image using an image-generative artificial intelligence engine based on a set of inputs from a user. In some embodiments, the set of inputs may include attributes of a clothing article, including color, style, occasion, age of the user, material, pattern, print, and length.

Embodiments may also include providing the user with an interactive user interface for entering the set of inputs, allowing the user to view the first realistic synthesized image after entering the inputs, and enabling the user to edit details of the clothing article, including any part of the collar and sleeve, and allowing the user to hand draw any shape or pattern on the clothing article.

Embodiments may also include generating a first output dataset from the first realistic synthesized image using an image-analysis engine. In some embodiments, the first output dataset may include information on color distribution and shape distribution of the first realistic synthesized image. Embodiments may also include determining a first score for the first output dataset using an artificial intelligence scoring network.

Embodiments may also include generating a second score manually with inputs from a set of fashion designers on the first realistic synthesized image. Embodiments may also include training the image-generative artificial intelligence engine to improve the generation of realistic images of fashion items based on the differences and interactions between the first score and the second score.

In some embodiments, the user can edit the details of the clothing article via a smart UI system. In some embodiments, the user may be able to change color, shape, style, print, and other details of the clothing article by a smart input device coupled to the smart UI system. In some embodiments, the user can upload inspirational photos and drawings to guide the AI generation of the clothes or a specific part of the clothes.

In some embodiments, the user can see how they or a user-selected model look like in the AI-generated clothes. In some embodiments, the user can upload their or a model's photo to the system. In some embodiments, the user can put accessories on the user's body. In some embodiments, the accessories can be bags, earrings, headbands, makeups. In some embodiments, the user can upload a picture of a bag. In some embodiments, the first realistic synthesized image contains the picture of the bag with the user.

Embodiments of the present disclosure may also include a system for generating and scoring user-customized fashion images, including a memory including an image-generative artificial intelligence engine trained to generate realistic images of fashion items. Embodiments may also include an image-analysis engine trained to generate output of images.

Embodiments may also include an artificial intelligence scoring network trained to score the realistic images of fashion items generated by the image-generative artificial intelligence engine. Embodiments may also include at least one processor. Embodiments may also include at least one non-transitory computer-readable storage medium storing instructions that, when executed by the at least one processor, cause the system to generate a first realistic synthesized image utilizing the image-generative artificial intelligence engine based on a set of inputs from a user.

In some embodiments, the set of inputs may include attributes of a clothing article. In some embodiments, the attributes of the clothing article may include color, style, occasion, age of the user, material, pattern, print, and sleeve length. Embodiments may also include generate a first output dataset from the first realistic synthesized image utilizing the image-analysis engine.

In some embodiments, the first output dataset may include information on color distribution and shape distribution of the first realistic synthesized image. Embodiments may also include determine a first score for the first output dataset utilizing the artificial intelligence scoring network. Embodiments may also include generate a second score manually with inputs of a set of fashion designers based on the first realistic synthesized image. Embodiments may also include train the image-generative artificial intelligence engine for better generation of realistic images of fashion items based on the differences and interactions of the first score and the second score.

In some embodiments, the user can edit the details of the clothing article via a smart UI system. In some embodiments, the user may be able to change color, shape, style, print, and other details of the clothing article by a smart input device coupled to the smart UI system. In some embodiments, the user can upload inspirational photos and drawings to guide the AI generation of the clothes or a specific part of the clothes.

In some embodiments, the user can see how they or a user-selected model look like in the AI-generated clothes. In some embodiments, the user can upload their or a model's photo to the system. In some embodiments, the user can put accessories on the user's body. In some embodiments, the accessories can be bags, earrings, headbands, makeups. In some embodiments, the user can upload a picture of a bag. In some embodiments, the first realistic synthesized image contains the picture of the bag with the user.

### BRIEF DESCRIPTION OF THE FIGURES

FIG. 1 is a block diagram illustrating a system, according to some embodiments of the present disclosure.

FIG. 2 is a flowchart illustrating a method for generating, according to some embodiments of the present disclosure.

FIG. 3 is a block diagram illustrating a system, according to some embodiments of the present disclosure.

FIG. 4 is a diagram showing an example of a method for generating and scoring user-customized fashion images, according to some embodiments of the present disclosure.

FIG. 5 is a diagram showing a second example of a method for generating and scoring user-customized fashion images, according to some embodiments of the present disclosure.

FIG. 6 is a diagram showing a third example of a method for generating and scoring user-customized fashion images, according to some embodiments of the present disclosure.

FIG. 7 is a diagram showing a fourth example of a method for generating and scoring user-customized fashion images, according to some embodiments of the present disclosure.

FIG. 8 is a diagram showing a fifth example of a method for generating and scoring user-customized fashion images, according to some embodiments of the present disclosure.

FIG. 9 is a diagram showing a sixth example of a method for generating and scoring user-customized fashion images, according to some embodiments of the present disclosure.

FIG. 10 is a diagram showing a seventh example of a method for generating and scoring user-customized fashion images, according to some embodiments of the present disclosure.

### DETAILED DESCRIPTION

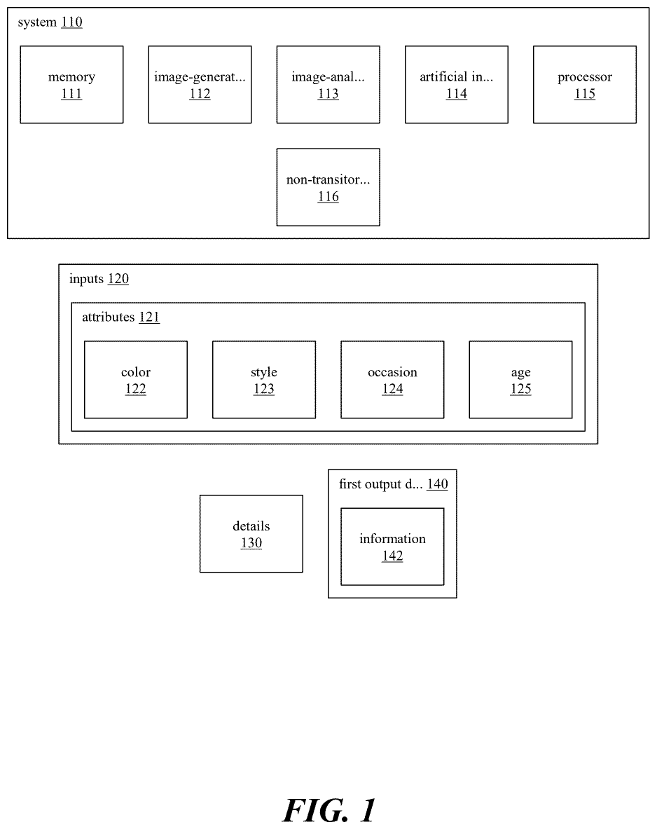

FIG. 1 is a block diagram that describes a system 110, according to some embodiments of the present disclosure. In some embodiments, the system 110 may include a memory 111, an image-generative artificial intelligence engine 112 trained to generate realistic images of fashion items, an image-analysis engine 113 trained to generate output of images, an artificial intelligence scoring network 114 trained to score the realistic images of fashion items generated by the image-generative artificial intelligence engine 112, and at least one processor 115. The system 110 may also include at least one non-transitory computer-readable storage medium storing instructions 116 that, when executed by the at least one processor 115, cause the system 110 to:

In some embodiments, generate a first realistic synthesized image utilizing the image-generative artificial intelligence engine 112 based on a set of inputs 120 from a user. Generate a first output dataset 140 from the first realistic synthesized image utilizing the image-analysis engine 113. Determine a first score for the first output dataset 140 utilizing the artificial intelligence scoring network 114. Generate a second score with inputs of a set of fashion designers on the first realistic synthesized image.

In some embodiments, train the image-generative artificial intelligence engine 112 for better generation of realistic images of fashion items based on the differences and interactions of the first score and the second score. The set of inputs 120 may include attributes 121 of a clothing article. The attributes 121 may include color 122, style 123, and occasion 124. The attributes 121 may also include age 125 of the user, material, pattern, print, and length.

In some embodiments, the attributes 121 of the clothing article. The user may be provided with an interactive user interface for entering the set of inputs 120. The user may be able to view the first realistic synthesized image after the user may enter the set of inputs 120. The user may be able to edit details 130 of the clothing article. Any part of the clothing article. The any part of the clothing article. At least any part of collar and any part of sleeve. The user may be able to hand draw any shape or pattern on the clothing article. The first output dataset 140 may include information 142 on color distribution and shape distribution of the first realistic synthesized image.

In some embodiments, the user can edit the details 130 of the clothing article via a smart UI system. The user may be able to change color, shape, style, print, and other details of the clothing article by a smart input device coupled to the smart UI system. The user can upload inspirational photos and drawings to guide the AI generation of the clothes or a specific part of the clothes. In some embodiments, the user can see how they or a user-selected model may look like in the AI-generated clothes. The user can upload their or a model's photo to the system 110. The user can put accessories on the user's body. The accessories can be bags, earrings, headbands, makeups. In some embodiments, the user can upload a picture of a bag. The picture of the bag with the user.

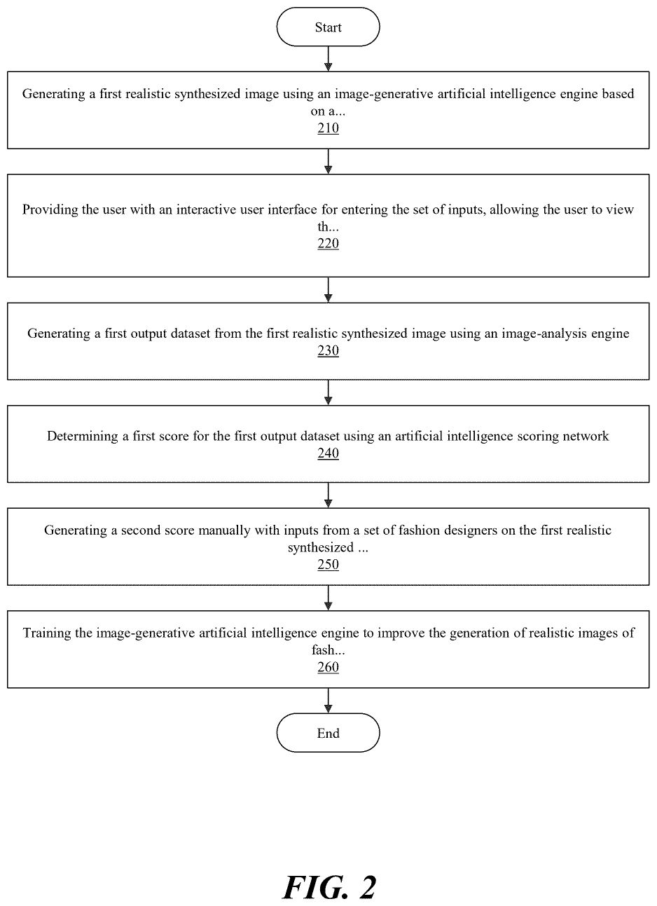

FIG. 2 is a flowchart that describes a method for generating, according to some embodiments of the present disclosure. In some embodiments, at 210, the method may include generating a first realistic synthesized image using an image-generative artificial intelligence engine based on a set of inputs from a user. At 220, the method may include providing the user with an interactive user interface for entering the set of inputs, allowing the user to view the first realistic synthesized image after entering the inputs, and enabling the user to edit details of the clothing article, including any part of the collar and sleeve, and allowing the user to hand draw any shape or pattern on the clothing article.

In some embodiments, at 230, the method may include generating a first output dataset from the first realistic synthesized image using an image-analysis engine. At 240, the method may include determining a first score for the first output dataset using an artificial intelligence scoring network. At 250, the method may include generating a second score manually with inputs from a set of fashion designers on the first realistic synthesized image. At 260, the method may include training the image-generative artificial intelligence engine to improve the generation of realistic images of fashion items based on the differences and interactions between the first score and the second score. The set of inputs comprises attributes of a clothing article, including color, style, occasion, age of the user, material, pattern, print, and length. The first output dataset comprises information on color distribution and shape distribution of the first realistic synthesized image.

In some embodiments, the user can edit the details of the clothing article via a smart UI system. The user may be able to change color, shape, style, print, and other details of the clothing article by a smart input device coupled to the smart UI system. The user can upload inspirational photos and drawings to guide the AI generation of the clothes or a specific part of the clothes. In some embodiments, the user can see how they or a user-selected model may look like in the AI-generated clothes. The user can upload their or a model's photo to the system. The user can put accessories on the user's body. The accessories can be bags, earrings, headbands, makeups. In some embodiments, the user can upload a picture of a bag. The first realistic synthesized image may contain the picture of the bag with the user.

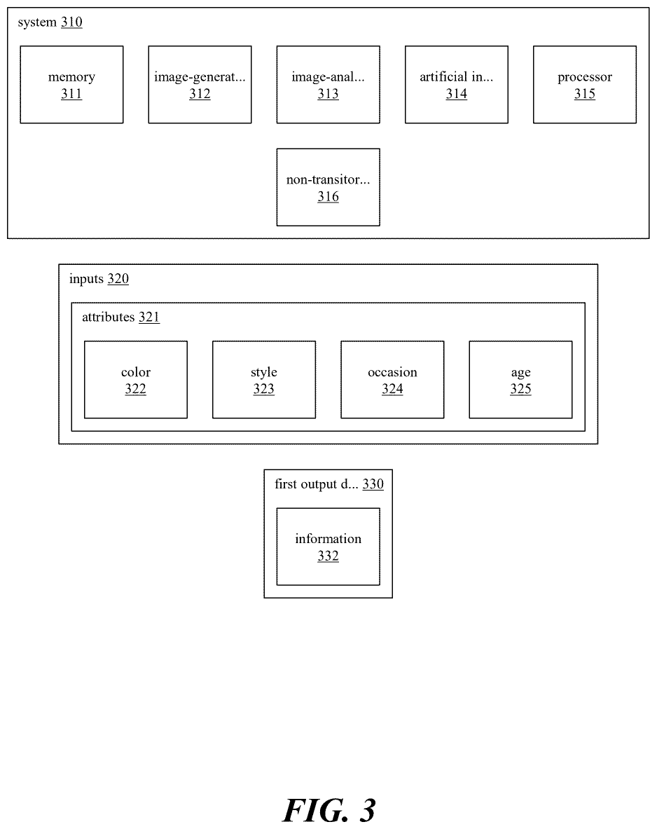

FIG. 3 is a block diagram that describes a system 310, according to some embodiments of the present disclosure. In some embodiments, the system 310 may include a memory 311, an image-generative artificial intelligence engine 312 trained to generate realistic images of fashion items, an image-analysis engine 313 trained to generate output of images, an artificial intelligence scoring network 314 trained to score the realistic images of fashion items generated by the image-generative artificial intelligence engine 312, and at least one processor 315. The system 310 may also include at least one non-transitory computer-readable storage medium storing instructions 316 that, when executed by the at least one processor 315, cause the system 310 to:

In some embodiments, generate a first realistic synthesized image utilizing the image-generative artificial intelligence engine 312 based on a set of inputs 320 from a user. Generate a first output dataset 330 from the first realistic synthesized image utilizing the image-analysis engine 313. Determine a first score for the first output dataset 330 utilizing the artificial intelligence scoring network 314. Generate a second score manually with inputs of a set of fashion designers based on the first realistic synthesized image.

In some embodiments, train the image-generative artificial intelligence engine 312 for better generation of realistic images of fashion items based on the differences and interactions of the first score and the second score. The set of inputs 320 may include attributes 321 of a clothing article. The attributes 321 may include color 322, style 323, and occasion 324. The attributes 321 may also include age 325 of the user, material, pattern, print, and sleeve length. The attributes 321 of the clothing article. The first output dataset 330 may include information 332 on color distribution and shape distribution of the first realistic synthesized image.

In some embodiments, the user can edit the details of the clothing article via a smart UI system. The user may be able to change color, shape, style, print, and other details of the clothing article by a smart input device coupled to the smart UI system. The user can upload inspirational photos and drawings to guide the AI generation of the clothes or a specific part of the clothes. In some embodiments, the user can see how they or a user-selected model may look like in the AI-generated clothes. The user can upload their or a model's photo to the system 310. The user can put accessories on the user's body. The accessories can be bags, earrings, headbands, makeups. In some embodiments, the user can upload a picture of a bag. The picture of the bag with the user.

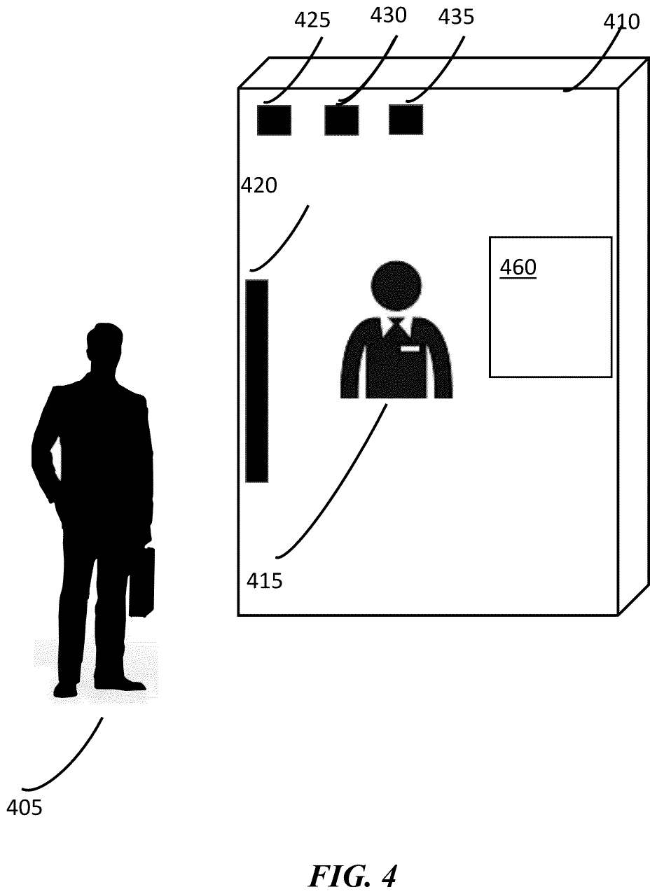

FIG. 4 is a diagram showing an example that describes a first example of a method for generating and scoring user-customized fashion images, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods and systems described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to be used. In some embodiments, other users can use this service descripted in this paragraph.

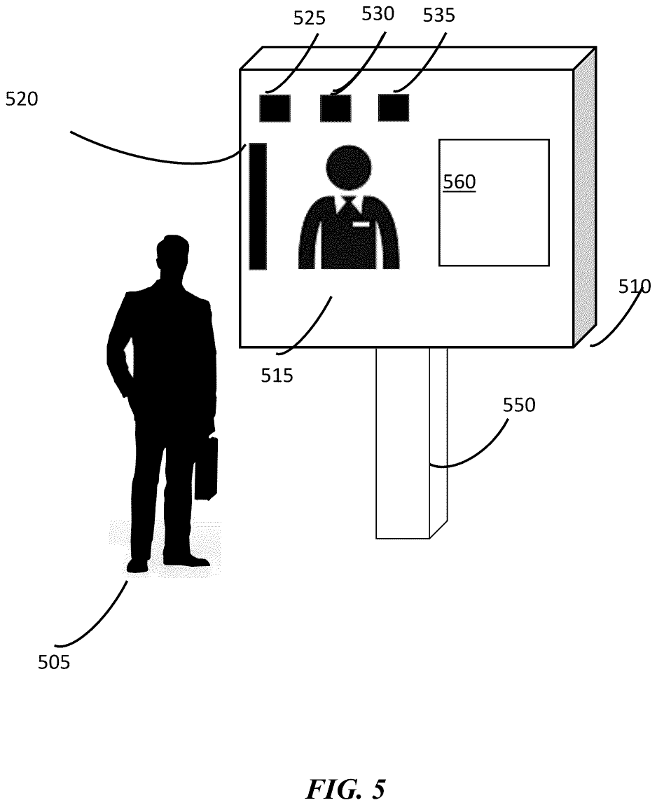

FIG. 5 is a diagram showing a second example of a method for generating and scoring user-customized fashion images, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods and systems described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3., with the help of interactive panel 520. In some embodiments, user 505 can choose what language to be used. In some embodiments, other users can use this service descripted in this paragraph.

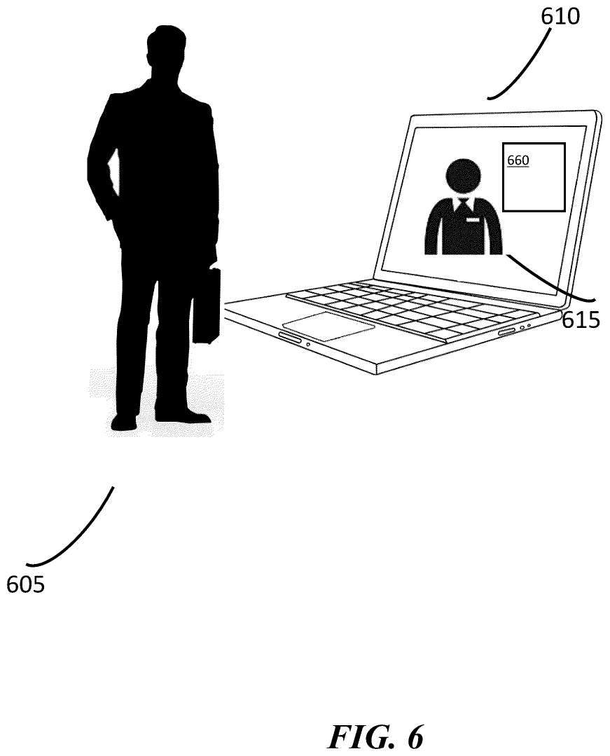

FIG. 6 is a diagram showing a third example of a method for generating and scoring user-customized fashion images, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer, or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods and systems described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph.

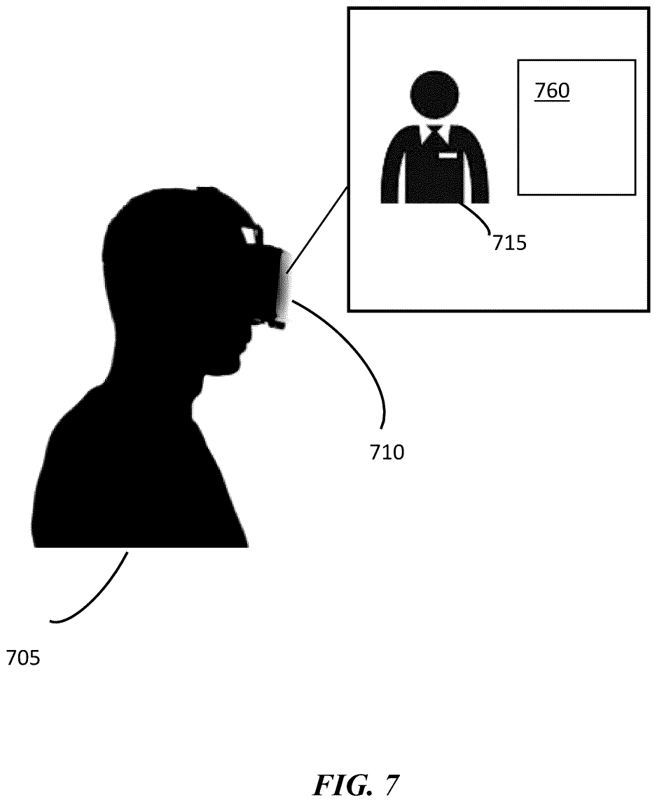

FIG. 7 is a diagram showing a fourth example of a method for generating and scoring user-customized fashion images, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods and systems described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service descripted in this paragraph.

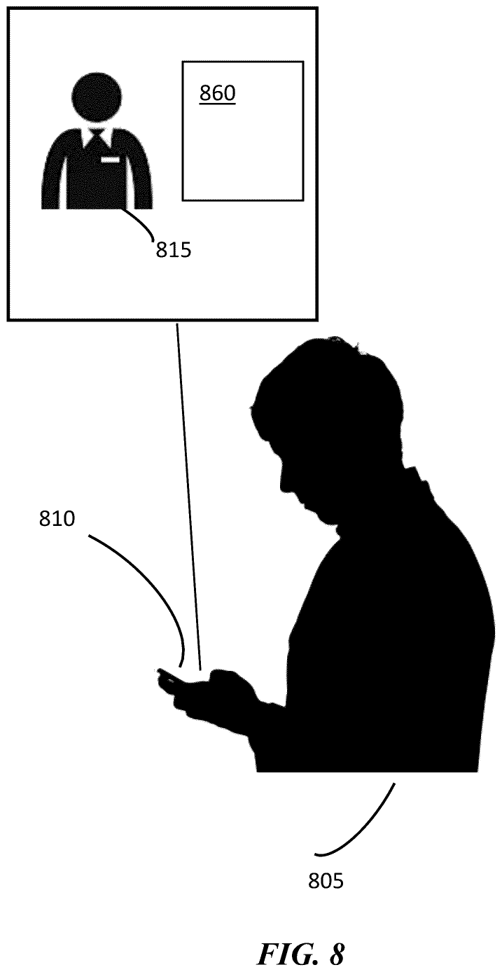

FIG. 8 is a diagram showing a fifth example of a method for generating and scoring user-customized fashion images, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods and systems described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph.

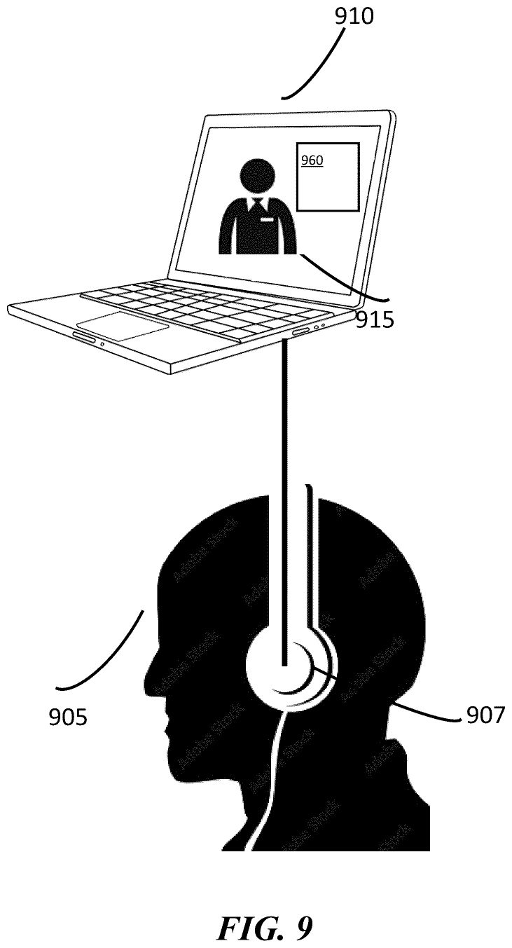

FIG. 9 is a diagram showing a sixth example of a method for generating and scoring user-customized fashion images, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices relate to a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods and systems described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph.

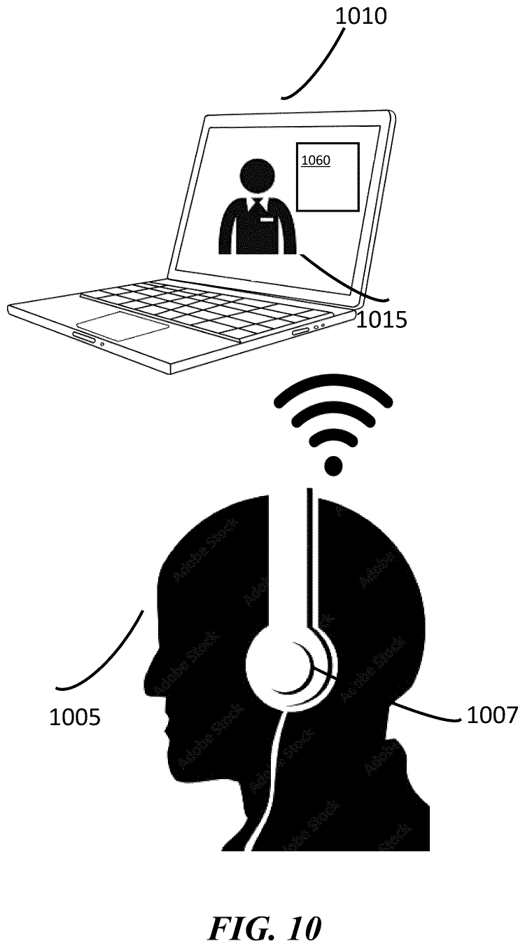

FIG. 10 is a diagram showing a seventh example of a method for generating and scoring user-customized fashion images, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices relate to wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods and systems described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph.

1. A system for generating and scoring user-customized fashion images, comprising:
a memory comprising:
an image-generative artificial intelligence engine trained to generate realistic images of fashion items;
an image-analysis engine trained to generate output of images; and
an artificial intelligence scoring network trained to score the realistic images of fashion items generated by the image-generative artificial intelligence engine;
at least one processor; and
at least one non-transitory computer-readable storage medium storing instructions that, when executed by the at least one processor, cause the system to:
generate a first realistic synthesized image utilizing the image-generative artificial intelligence engine based on a set of inputs from a user, wherein the set of inputs comprises attributes of a clothing article, wherein the attributes of the clothing article comprise color, style, occasion, age of the user, material, pattern, print, and length, wherein the user is provided with an interactive user interface for entering the set of inputs, wherein the user is able to view the first realistic synthesized image after the user enters the set of inputs, wherein the user is able to edit details of the clothing article, wherein the details comprises any part of the clothing article, wherein the any part of the clothing article comprises at least any part of collar and any part of sleeve, wherein the user is able to hand draw any shape or pattern on the clothing article;
generate a first output dataset from the first realistic synthesized image utilizing the image-analysis engine wherein the first output dataset comprises information on color distribution and shape distribution of the first realistic synthesized image;
determine a first score for the first output dataset utilizing the artificial intelligence scoring network;
generate a second score with inputs of a set of fashion designers on the first realistic synthesized image; and
train the image-generative artificial intelligence engine for better generation of realistic images of fashion items based on the differences and interactions of the first score and the second score.

2. The system for generating and scoring user-customized fashion images of claim 1, wherein the user can edit the details of the clothing article via a smart UI system, wherein the user is able to change color, shape, style, print, and other details of the clothing article by a smart input device coupled to the smart UI system, wherein the user can upload inspirational photos and drawings to guide the AI generation of the clothes or a specific part of the clothes.

3. The system for generating and scoring user-customized fashion images of claim 1, wherein the user can see how they or a user-selected model look like in the AI-generated clothes, wherein the user can upload their or a model's photo to the system, wherein the user can put accessories on the user's body, wherein the accessories can be bags, earrings, headbands, makeups.

4. The system for generating and scoring user-customized fashion images of claim 1, wherein the user can upload a picture of a bag, wherein the first realistic synthesized image contains the picture of the bag with the user.

5. A method for generating and scoring user-customized fashion images, comprising:
generating a first realistic synthesized image using an image-generative artificial intelligence engine based on a set of inputs from a user, wherein the set of inputs comprises attributes of a clothing article, including color, style, occasion, age of the user, material, pattern, print, and length;
providing the user with an interactive user interface for entering the set of inputs, allowing the user to view the first realistic synthesized image after entering the inputs, and enabling the user to edit details of the clothing article, including any part of the collar and sleeve, and allowing the user to hand draw any shape or pattern on the clothing article;
generating a first output dataset from the first realistic synthesized image using an image-analysis engine, wherein the first output dataset comprises information on color distribution and shape distribution of the first realistic synthesized image;
determining a first score for the first output dataset using an artificial intelligence scoring network;
generating a second score manually with inputs from a set of fashion designers on the first realistic synthesized image;
training the image-generative artificial intelligence engine to improve the generation of realistic images of fashion items based on the differences and interactions between the first score and the second score.

6. The method for generating and scoring user-customized fashion images of claim 5, wherein the user can edit the details of the clothing article via a smart UI system, wherein the user is able to change color, shape, style, print, and other details of the clothing article by a smart input device coupled to the smart UI system, wherein the user can upload inspirational photos and drawings to guide the AI generation of the clothes or a specific part of the clothes.

7. The method for generating and scoring user-customized fashion images of claim 5, wherein the user can see how they or a user-selected model look like in the AI-generated clothes, wherein the user can upload their or a model's photo to the system, wherein the user can put accessories on the user's body, wherein the accessories can be bags, earrings, headbands, makeups.

8. The method for generating and scoring user-customized fashion images of claim 5, wherein the user can upload a picture of a bag, wherein the first realistic synthesized image contains the picture of the bag with the user.

9. A system for generating and scoring user-customized fashion images, comprising:
a memory comprising:
an image-generative artificial intelligence engine trained to generate realistic images of fashion items;
an image-analysis engine trained to generate output of images; and
an artificial intelligence scoring network trained to score the realistic images of fashion items generated by the image-generative artificial intelligence engine;
at least one processor; and
at least one non-transitory computer-readable storage medium storing instructions that, when executed by the at least one processor, cause the system to:
generate a first realistic synthesized image utilizing the image-generative artificial intelligence engine based on a set of inputs from a user, wherein the set of inputs comprises attributes of a clothing article, wherein the attributes of the clothing article comprise color, style, occasion, age of the user, material, pattern, print, and sleeve length;
generate a first output dataset from the first realistic synthesized image utilizing the image-analysis engine wherein the first output dataset comprises information on color distribution and shape distribution of the first realistic synthesized image;
determine a first score for the first output dataset utilizing the artificial intelligence scoring network;
generate a second score manually with inputs of a set of fashion designers based on the first realistic synthesized image;
train the image-generative artificial intelligence engine for better generation of realistic images of fashion items based on the differences and interactions of the first score and the second score.

10. The system for generating and scoring user-customized fashion images of claim 9, wherein the user can edit the details of the clothing article via a smart UI system, wherein the user is able to change color, shape, style, print, and other details of the clothing article by a smart input device coupled to the smart UI system, wherein the user can upload inspirational photos and drawings to guide the AI generation of the clothes or a specific part of the clothes.

11. The system for generating and scoring user-customized fashion images of claim 9, wherein the user can see how they or a user-selected model look like in the AI-generated clothes, wherein the user can upload their or a model's photo to the system, wherein the user can put accessories on the user's body, wherein the accessories can be bags, earrings, headbands, makeups.

12. The system for generating and scoring user-customized fashion images of claim 9, wherein the user can upload a picture of a bag, wherein the first realistic synthesized image contains the picture of the bag with the user.
